(19) United States
(12) Patent Application Publication
(10) Pub. No.: US 2010/0059354 A1
(43) Pub. Date: Mar. 11, 2010

(54) KEYBOARD AND ELECTRONIC DEVICE

(75) Inventors: Su-Ching Hsu, Taipei (TW); Chi-Feng Li, Taipei (TW); Chih-Ho Hsieh, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/507,058

(22) Filed: Jul. 21, 2009

(30) Foreign Application Priority Data
Sep. 5, 2008 (TW) 97134213

(51) Int. Cl. H01H 13/76

(52) U.S. Cl. 200/5 A; 200/314

(57) ABSTRACT

A keyboard and an electronic device are provided. The electronic device includes a host, a display module and a keyboard. The display module is electrically connected to the host. The keyboard is electrically connected to the host. The keyboard includes a circuit membrane, a lighting film and a plurality of keycaps. The circuit membrane has a plurality of key contacts. The circuit membrane and the lighting film are stacked, and the lighting film emits light with different wavelengths according to different voltages applied thereon. The keycaps are disposed on the circuit membrane and the lighting film and located above the key contacts.

### CROSS-REFERENCE TO RELATED APPLICATION

This application claims the priority benefit of Taiwan application serial no. 97134213, filed on Sep. 5, 2008. The entirety of the above-mentioned patent application is hereby incorporated by reference herein and made a part of this specification.

### BACKGROUND OF THE INVENTION

1. Field of the Invention

The present invention relates to a keyboard and an electronic device. More particularly, the present invention relates to a keyboard having a lighting film and an electronic device using the same.

2. Description of Related Art

In a current information age, people increasingly depend on electronic devices, and to meet demands of high performance and portability of the electronic devices, the electronic devices, such as notebook computers become indispensable application tools in people's daily life. Generally, a human-machine interface such as a keyboard is disposed on a casing of the notebook computer for a user to input commands, and an internal system of the notebook computer can automatically execute the commands.

To facilitate the user to operate the notebook computer under insufficient environmental lighting, a plurality of light-emitting diodes (LEDs) is generally disposed underneath the keyboard for lighting the keyboard. However, to evenly distribute light provided by the LEDs to each of keys on the keyboard, a light-guiding device has to be applied. Therefore, a whole thickness of the notebook computer is increased. Moreover, since the keys of a conventional keyboard are individually assembled, water or dirt can be dropped into gaps among the keys, and even the keys can be fallen off. In addition, since the LEDs disposed underneath the keyboard do not have a shutdown mechanism according to requirement of the user, the LEDs are kept lighting under a sufficient environmental lighting, which may cause a waste of power.

### SUMMARY OF THE INVENTION

The present invention is directed to a keyboard, which has a self-illuminating function and a relatively small thickness.

The present invention is directed to an electronic device, which applies a keyboard having a self-illuminating function and a relatively small thickness.

The present invention provides a keyboard including a circuit membrane, a lighting film and a plurality of keycaps. The circuit membrane has a plurality of key contacts. The circuit membrane and the lighting film are stacked, and the lighting film emits light with different wavelengths according to different voltages applied thereon. The keycaps are disposed on the circuit membrane and the lighting film and located above the key contacts.

In an embodiment of the present invention, the keyboard further includes a casing, and the keycaps, the lighting film and the circuit membrane are disposed in the casing.

The present invention provides an electronic device including a host, a display module and a keyboard. The display module is electrically connected to the host. The keyboard is electrically connected to the host. The keyboard includes a circuit membrane, a lighting film and a plurality of keycaps. The circuit membrane has a plurality of key contacts. The circuit membrane and the lighting film are stacked, and the lighting film emits light with different wavelengths according to different voltages applied thereon. The keycaps are disposed on the circuit membrane and the lighting film and located above the key contacts.

In an embodiment of the present invention, the display module is pivotally connected to the host.

In an embodiment of the present invention, the lighting film includes a first electrode layer, a second electrode layer and an electro-luminance (EL) material layer. The EL material layer is disposed between the first electrode layer and the second electrode layer.

In an embodiment of the present invention, each of the keycaps includes a dome-shaped film and a key slice. The dome-shaped film is disposed on the lighting film and the circuit membrane. The key slice is disposed on the dome-shaped film and has a transparent pattern. Moreover, a surface of each of the dome-shaped films that faces the lighting film and the circuit membrane has a bump.

In an embodiment of the present invention, the keyboard further includes a support plate, and the lighting film and the circuit membrane are disposed between the keycaps and the support plate.

In an embodiment of the present invention, the keyboard further includes a light sensor electrically connected to the lighting film for determining to turn on/off the lighting film according to a sensing result.

In an embodiment of the present invention, the keyboard further includes a switch electrically connected to the lighting film for turning on/off the lighting film.

In summary, in the keyboard and the electronic device of the present invention, since the lighting film is applied to illuminate the keyboard, the whole keyboard can be evenly illuminated while only a tiny thickness is increased. Accordingly, the keyboard and the electronic device of the present invention have a self-illuminating function and a relatively small thickness.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a keyboard according to an embodiment of the present invention.

FIG. 2 is a cross-sectional view of a keyboard of FIG. 1.

FIG. 3 is a schematic diagram illustrating an electronic device according to an embodiment of the present invention.

### DESCRIPTION OF EMBODIMENTS

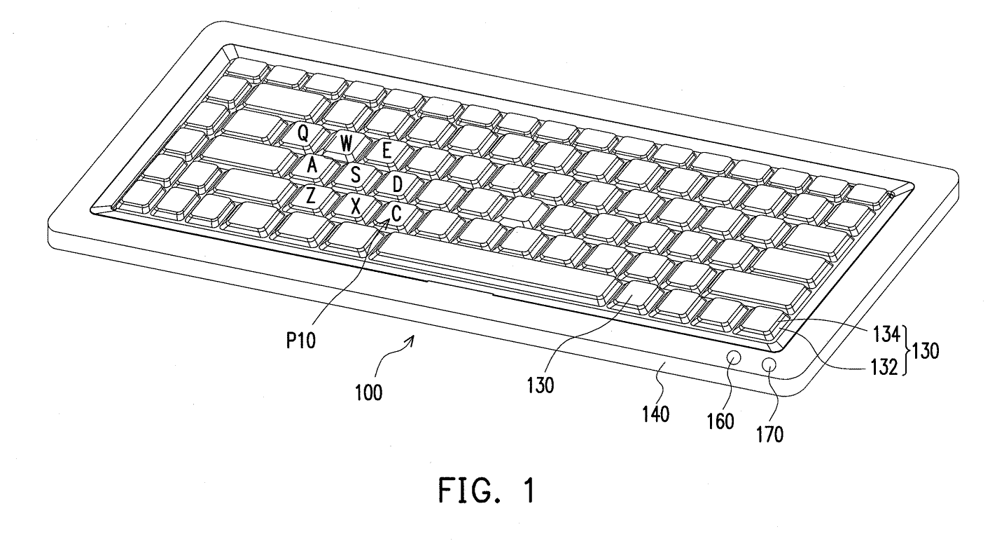

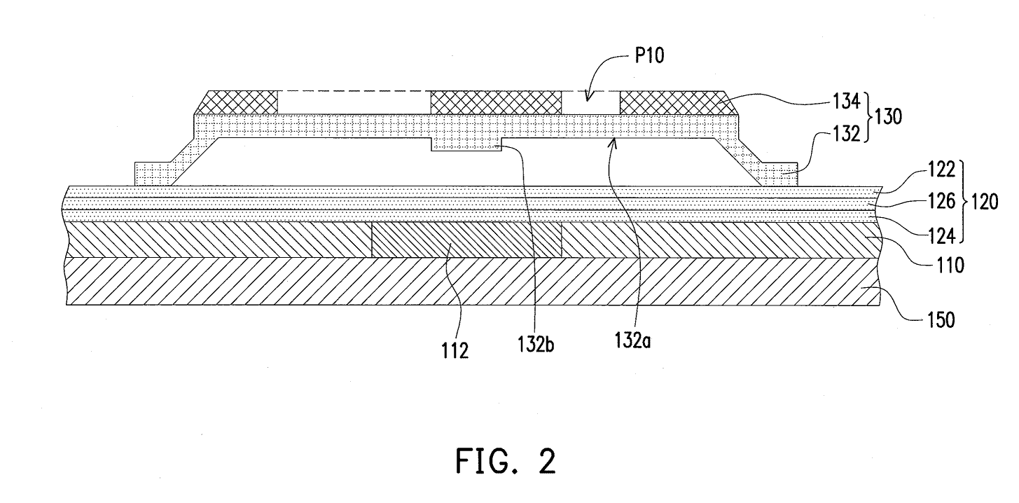

FIG. 1 is a schematic diagram illustrating a keyboard according to an embodiment of the present invention. FIG. 2 is a cross-sectional view of the keyboard of FIG. 1. Referring to FIG. 1 and FIG. 2, the keyboard 100 includes a circuit membrane 110, a lighting film 120 and a plurality of keycaps 130. The circuit membrane 110 has a plurality of key contacts 112. Since FIG. 2 is a cross-sectional view of the keyboard of FIG. 1, only one key contact 112 is illustrated in FIG. 2. The lighting film 120 is stacked to the circuit membrane 110. The keycaps 120 are disposed on the lighting film 120 and the circuit membrane 110. In detail, the keycaps 130 are located above the key contacts 112. The keyboard 100 of the present embodiment uses the lighting film 120 for illumination, by which not only a thickness of the lighting film 120 is very thin, but also the lighting film 120 can directly provide a planar light source, so that an extra light-guiding device is not required. Therefore, the keyboard 100 not only has a self-illuminating function to facilitate operations under an insufficient environmental lighting, but also has a relatively small thickness, which can meet a development trend of light and slim.

Moreover, the keyboard 100 of the present embodiment can serve as an external keyboard for a general desktop computer or a host of the other electronic device. Now, the keyboard 100 can further includes a casing 140. The keycaps 130, the lighting film 120 and the circuit membrane 110 are all disposed in the casing 140, and the keycaps 130 are exposed from the casing 140. Certainly, the keyboard 100 can also be built on a notebook computer, a cell phone or other electronic devices for inputting commands to the hosts of the electronic devices.

In the present embodiment, the lighting film 120 includes a first electrode layer 122, a second electrode layer 124 and an electro-luminance (EL) material layer 126. The EL material layer 126 is disposed between the first electrode layer 122 and the second electrode layer 124 for generating light according to currents provided by the first electrode layer 122 and the second electrode layer 124. In the present embodiment, the lighting film 120 is, for example, located between the keycaps 130 and the circuit membrane 110, though in other embodiments, the circuit membrane 110 can also be located between the keycaps 130 and the lighting film 120. Moreover, material of the first electrode layer 122 and the second electrode layer 124 can be a transparent conductive material such as indium tin oxide (ITO) or other transparent conductive materials. However, the material of one of the first electrode layer 122 and the second electrode layer 124 can also be a non-transparent conductive material, as long as such electrode layer is not required to be transparent. Moreover, the lighting film 120 can also be the other lighting film besides the EL film.

By selecting the luminance material, the lighting film 120 can emit light with different wavelengths according to different voltages applied thereon, for example, blue light and green light. By such means, not only the user can select the light with different wavelengths according to his preference, but also a power state or occurrence of other events can be indicated by changing the wavelength of the light. The voltage exerted to the lighting film 120 can be provided by a battery (not shown) disposed in the keyboard 100. Alternatively, the voltage exerted to the lighting film 120 can be provided by the host connected to the keyboard 100 via a connection line (not shown). The wavelengths of the light emitted from the lighting film 120 can be controlled via a switch key disposed on the keyboard 100. Related commands can be output to the connected host from the keyboard 100, and then the host outputs the corresponding voltages to change the wavelengths of the light emitted from the lighting film 120. Certainly, the host can also change the wavelengths of the light emitted from the lighting film 120 according to a predetermined program, so as to indicate for example, the power state or occurrence of the other events.

In the present embodiment, each of the keycaps 130 includes a dome-shaped film 132 and a key slice 134. The dome-shaped film 132 is disposed on the lighting film 120 and the circuit membrane 110. Since the dome-shaped film 132 is deformable, it can provide a touch sense to the user when being pressed, so that a complicated X-type bracket is unnecessary. Moreover, the dome-shaped films 132 can be fabricated on a same film, which can not only prevent entering of water or dirt, but can also increase a convenience of assembly. Material of the dome-shaped film 132 is for example silicone or other suitable materials. The key slice 134 is disposed on the dome-shaped film 132 and has a transparent pattern P10. In FIG. 1, only the transparent patterns P10 of a part of the key slices 134 are illustrated. The transparent patterns P10 for example, include English letters, numbers or other icons. Certainly, the key slice 134 of the keycap 130 that serves as a space key does not require the transparent pattern. Moreover, a surface 132a of each of the dome-shaped films 132 that faces the lighting film 120 and the circuit membrane 110 has a bump 132b for increasing a success rate of sending a signal when the user presses the keycap 130 to trigger the key contact 112 of the circuit membrane 110. Moreover, the keyboard 100 can further include a support plate 150, and the lighting film 120 and the circuit membrane 110 are disposed between the keycaps 130 and the support plate 150.

In addition, the keyboard 100 can further include a light sensor 160 electrically connected to the lighting film 120 for determining to turn on/off the lighting film 120 according to a sensing result. By such means, the lighting film 120 can be automatically turned on under insufficient environmental lighting, and turned off under sufficient environmental lighting, so as to save power. Moreover, the keyboard 100 can also include a switch 170 electrically connected to the lighting film 120 for turning on/off the lighting film 120 according to a selection of the user.

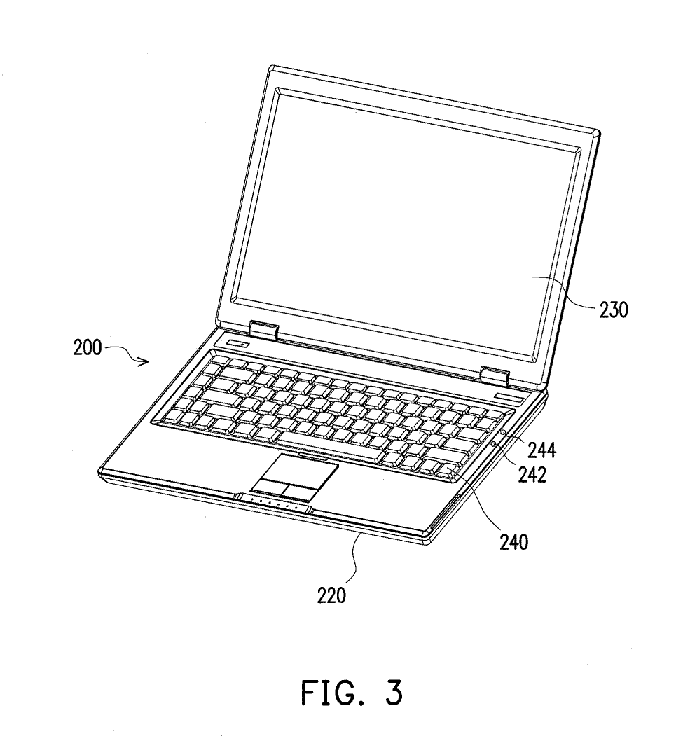

FIG. 3 is a schematic diagram illustrating an electronic device according to an embodiment of the present invention. Referring to FIG. 3, the electronic device 200 of the present embodiment includes a host 220, a display module 230 and a keyboard 240. The display module 230 is connected to the host 220 and is controlled by the host 220. In the present embodiment, the display module 230 is pivotally connected to the host 220. The keyboard 240 is similar to the keyboard 100 of FIG. 1, though the keyboard 240 has not an independent casing. A light sensor 242 and a switch 244 can also be selectively configured to the electronic device 200, and other similarities are not repeated. The keyboard 240 is connected to the host 220, and the light sensor 242 and the switch 244 can be connected to the lighting film (not shown) via the host 220. The electronic device 200 of FIG. 3 is, for example, a notebook computer, and in other embodiments, the electronic device 200 can also be a handheld device such as a bar-type phone, a flip phone or a personal digital assistant (PDA), etc.

In summary, in the keyboard and the electronic device of the present invention, since the lighting film with a tiny thickness is applied to evenly illuminate the keyboard, the thickness of the keyboard can be relatively small. Moreover, by selecting the luminance material of the lighting film, the lighting film can emit light with different wavelengths according to different requirements. In addition, various integral films are stacked to form the keyboard, so that key gaps can be avoided, and entering of water or dirt can be prevented. Moreover, the light sensor and the switch can be applied to achieve an automatic illumination function or a manual illumination function, so as to save the power.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keyboard, comprising:
a circuit membrane, having a plurality of key contacts;
a lighting film, stacked with the circuit membrane, and the lighting film emitting light with different wavelengths according to different voltages applied thereon; and
a plurality of keycaps, disposed on the lighting film and the circuit membrane and located above the key contacts.

2. The keyboard as claimed in claim 1, wherein the lighting film comprises:
a first electrode layer;
a second electrode layer; and
an electro-luminance material layer, disposed between the first electrode layer and the second electrode layer.

3. The keyboard as claimed in claim 1, wherein each of the keycaps comprises:
a dome-shaped film, disposed on the lighting film and the circuit membrane; and
a key slice, disposed on the dome-shaped film, and having a transparent pattern.

4. The keyboard as claimed in claim 3, wherein a surface of each of the dome-shaped films that faces the lighting film and the circuit membrane has a bump.

5. The keyboard as claimed in claim 1 further comprising a support plate, wherein the lighting film and the circuit membrane are disposed between the keycaps and the support plate.

6. The keyboard as claimed in claim 1 further comprising a casing, wherein the keycaps, the lighting film and the circuit membrane are disposed in the casing.

7. The keyboard as claimed in claim 1 further comprising a light sensor electrically connected to the lighting film for determining to turn on/off the lighting film according to a sensing result.

8. The keyboard as claimed in claim 1 further comprising a switch electrically connected to the lighting film for turning on/off the lighting film.

9. An electronic device, comprising:
a host;
a display module, connected to the host;
a keyboard, connected to the host, and comprising:
a circuit membrane, having a plurality of key contacts;
a lighting film, stacked with the circuit membrane, and the lighting film emitting light with different wavelengths according to different voltages applied thereon; and
a plurality of keycaps, disposed on the lighting film and the circuit membrane and located above the key contacts.

10. The electronic device as claimed in claim 9, wherein the display module is pivotally connected to the host.

11. The electronic device as claimed in claim 9, wherein the lighting film comprises:
a first electrode layer;
a second electrode layer; and
an electro-luminance material layer, disposed between the first electrode layer and the second electrode layer.

12. The electronic device as claimed in claim 9, wherein each of the keycaps comprises:
a dome-shaped film, disposed on the lighting film and the circuit membrane; and
a key slice, disposed on the dome-shaped film, and having a transparent pattern.

13. The electronic device as claimed in claim 12, wherein a surface of each of the dome-shaped films that faces the lighting film and the circuit membrane has a bump.

14. The electronic device as claimed in claim 9, wherein the keyboard further comprises a support plate, wherein the lighting film and the circuit membrane are disposed between the keycaps and the support plate.

15. The electronic device as claimed in claim 9, wherein the keyboard further comprises a light sensor electrically connected to the lighting film for determining to turn on/off the lighting film according to a sensing result.

16. The electronic device as claimed in claim 9, wherein the keyboard further comprises a switch electrically connected to the lighting film for turning on/off the lighting film.
